(19) United States
(12) Patent Application Publication
(10) Pub. No.: US 2008/0013994 A1
(43) Pub. Date: Jan. 17, 2008

(54) Fuser roller, fusing unit, image-forming apparatus, and method thereof

(75) Inventors: Seung-jun Lee, Suwon-si (KR); Hwan-guem Kim, Seoul (KR); Dong-jin Seol, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 11/699,356

(22) Filed: Jan. 30, 2007

(30) Foreign Application Priority Data
Jul. 13, 2006 (KR) 2006-65902

(51) Int. Cl. G03G 15/20

(52) U.S. Cl. 399/333

(57) ABSTRACT

A fuser roller and a fusing unit including the fuser roller are to be used in an image-forming apparatus. The fuser roller includes a tubular fusing portion, an inner tube, and a heating portion. The inner tube is inserted into the fusing portion. The heating portion is installed to enclose an outer surface of the inner tube and press against an inner surface of the fusing portion, and to radiate heat. The fusing portion is surface treated to have a roughness factor of Ra 3-5μm.

### CROSS-REFERENCE TO RELATED APPLICATIONS

This application claims priority from Korean Patent Application No. 10-2006-0065902, filed on Jul. 13, 2006, in the Korean Intellectual Property Office, the disclosure of which is incorporated herein in its entirety by reference.

### BACKGROUND OF THE INVENTION

1. Field of the Invention

The present general inventive concept relates to a fuser roller, a fusing unit, and an image-forming apparatus having the fusing unit, and more particularly, to an image-forming apparatus with a fuser roller that fuses toner onto a print medium to form an image by applying heat and pressure thereto, and a method thereof.

2. Description of the Related Art

An electronic photographic image-forming apparatus first forms an image to be printed as an electrostatic latent image on a photosensitive medium, then uses toner to develop the electrostatic latent image, transfers the developed toner image onto a print medium, and fuses the toner image onto the print medium.

FIG. 1 is a vertical sectional view illustrating an exemplary configuration of a conventional fusing unit of an image-forming apparatus.

Referring to FIG. 1, a fusing unit 10 includes a fuser roller 11 and a pressure roller 15.

The fuser roller 11 includes a tubular fusing portion 12 and a heating portion 14 with a halogen lamp, which is installed inside the center of the fusing portion 12. A release layer 13 coated with a release material such as polytetrafluoroethylene, e.g., TEFLON, (for releasing easily from a print medium) is formed around the outer surface of the fusing portion 12. Heat that is radiated through the heating portion 14 is transferred to the fusing portion 12, and is transferred to the outer surface of the fusing portion 12 by conduction through the fusing portion 12. The fusing portion 12 is thus heated to fuse a toner image 18 to a print medium 17.

The pressure roller 15 is installed below the fuser roller 11 to allow the print medium 17 to pass between the pressure roller 15 and the fuser roller 11. The pressure roller 15 receives elastic force, from an elastic member 16, in a direction which presses the pressure roller 15 against the fuser roller 11, so that the print medium 17 passing between the two rollers has pressure applied to it.

Therefore, the toner image 18 transferred to the print medium 17 is fused to the print medium 17 by the heat from the heating portion 14 and the pressure from the pressure roller 15.

Although the above-described fusing unit 10 is exemplary, most fusing units have the above configuration. The main differences lie in how the heating portion is structured and what material is used for the release layer.

In FIG. 1, only the release layer 13 is formed around the outer surface of the fusing portion 12, which is a configuration used to print monochromatic images. To print monochromatic images, a separator (not illustrated) is provided in the region where a print medium 17 is delivered, in order to separate the print medium 17 from the release layer 13, and therefore the nip formed by the fuser roller 11 contacting the pressure roller 15 can have a predetermined curvature.

When printing color images, the nip formed by the fuser roller 11 contacting the pressure roller 15 must be level, and an elastic layer (not illustrated) is provided between the release layer 13 and the fusing portion 12. Here, the elastic layer forms the nip, which ensures fusibility and changes the curl direction of the print medium toward the pressure roller 15 to prevent a so-called wrap jam from occurring on the fuser roller 11. To achieve this, a low hardness elastic layer must be used.

However, when a low hardness elastic layer is used, the heat radiated by the heating portion and the pressure from the pressure roller stresses the elastic layer and shortens the life of the pressure roller, and peeling between the fusing portion 12 and the elastic layer occurs, with the result that the elastic layer falls off.

### SUMMARY OF THE INVENTION

The present general inventive concept provides a fusing roller usable in an image-fusing apparatus. The fuser roller includes a fusing portion that is surface treated to improve binding and has a low hardness elastic layer. The general inventive concept also includes a fusing unit and an image-forming apparatus using the fuser roller.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing a fuser roller including a tubular fusing portion, an inner tube inserted into the fusing portion, and a heating portion installed to enclose an outer surface of the inner tube and press against an inner surface of the fusing portion, the heating portion radiating heat, wherein the fusing portion is formed of an aluminum material and has an outer surface that is surface treated to have a roughness factor of Ra 3-5 μm, and an elastic layer with a hardness of JIS-A (Japanese Industrial Standards) 2-10 degrees encloses the outer surface of the fusing portion.

The foregoing and/or other aspects of the present general inventive concept may also be achieved by providing a fuser unit including: a fuser roller including a tubular fusing portion, an inner tube inserted into the fusing portion, and a heating portion installed to enclose an outer surface of the inner tube and press against an inner surface of the fusing portion, the heating portion radiating heat; and a pressure roller engaged with the fuser roller and having an elastic bias toward the fuser roller to form a nip, wherein the fusing portion is formed of an aluminum material and has an outer surface that is surface treated to have a roughness factor of Ra 3-5 μm, and an elastic layer with a hardness of JIS-A (Japanese Industrial Standards) 2-10 degrees encloses the outer surface of the fusing portion.

The foregoing and/or other aspects and utilities of the present general inventive concept may also be achieved a fuser roller including: a tubular fusing portion; an inner tube disposed inside the fusing portion; and a heating portion to enclose an outer surface of the inner tube, to press against an inner surface of the fusing portion, and to radiate heat, wherein the fusing portion is surface treated to have a roughness factor of Ra 3-5 μm.

The fusing portion may include an aluminum material.

The fuser unit may have an elastic layer formed on the treated surface of the fusing portion, so that peeling of the elastic layer from the fusing portion is prevented.

The fuser roller may have an elastic layer with a hardness of JIS-A (Japanese Industrial Standards) 2-10 degrees that encloses an outer portion of the fusing portion.

The foregoing and/or other aspects and utilities of the present general inventive concept may also be achieved by a fuser roller including: a tubular fusing portion; an inner tube disposed inside into the fusing portion; and a heating portion to enclose an outer surface of the inner tube, to press against an inner surface of the fusing portion, and to radiate heat, wherein the fusing portion is treated by turning the fusing portion at 0.15 mm and being Parkerized.

The fusing portion may include a steel material.

The fuser roller may further include: an elastic layer with a hardness of JIS-A (Japanese Industrial Standards) 2-10 degrees that encloses an outer surface of the fusing portion.

The foregoing and/or other aspects and utilities of the present general inventive concept may also be achieved by an image-forming apparatus including: a developing unit to develop an electrostatic latent image; and a fusing unit including a fusing portion to attach the developed image to a print medium, a fuser roller including a heating portion to radiate heat, and a pressure roller engaged with the fuser roller, wherein the fusing portion has a roughness factor of Ra 3-5 μm.

The fusing portion may include aluminum.

The fuser unit may have an elastic layer formed on the fusing portion, so that a contract between the elastic layer and the fusing portion is increased.

The image-forming apparatus may have an elastic layer with a hardness of JIS-A (Japanese Industrial Standards) 2-10 degrees that encloses an outer portion of the fusing portion.

The foregoing and/or other aspects and utilities of the present general inventive concept may also be achieved by an image-forming apparatus including: a developing unit to develop an electrostatic latent image; and a fusing unit including a fusing portion to attach the developed image to a print medium, a fuser roller including a heating portion to radiate heat, and a pressure roller engaged with the fuser roller, wherein the fusing portion is treated by turning the fusing portion at 0.15 mm and being Parkerized.

The fusing portion may include a steel material.

The image-forming apparatus may include an elastic layer formed on an outer surface of the fusing portion, and having a hardness of JIS-A (Japanese Industrial Standards) 2-10 degrees.

The foregoing and/or other aspects and utilities of the present general inventive concept may also be achieved by a method of forming a fuser roller usable in an image-forming apparatus, the method including: forming a heating portion between a tubular fusing portion and an inner tube to generate heat, wherein the fusing portion is surface treated to have a roughness factor of Ra 3-5 μm.

The foregoing and/or other aspects and utilities of the present general inventive concept may also be achieved by a method of forming a fuser roller usable in an image-forming apparatus, the method including: forming a heater portion between a tubular fusing portion and an inner tube to generate heat, wherein the fusing portion is treated by turning the fusing portion at 0.15 mm and being Parkerized.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a vertical sectional view illustrating an exemplary configuration of a conventional fusing unit of an image-forming apparatus;

FIG. 2 is a schematic vertical sectional view illustrating an exemplary configuration of an image-forming apparatus having a fusing unit according to the general inventive concept;

FIG. 3 is a vertical sectional view of a fusing unit illustrating an image-forming apparatus according to the general inventive concept;

FIG. 4 is a cross sectional view illustrating the structure of the fuser roller in FIG. 3;

FIG. 5 is an enlarged cross sectional view illustrating a region A in FIG. 4, according to an embodiment of the general inventive concept; and

FIG. 6 is an enlarged cross sectional view illustrating a region A in FIG. 4, according to another embodiment of the general inventive concept.

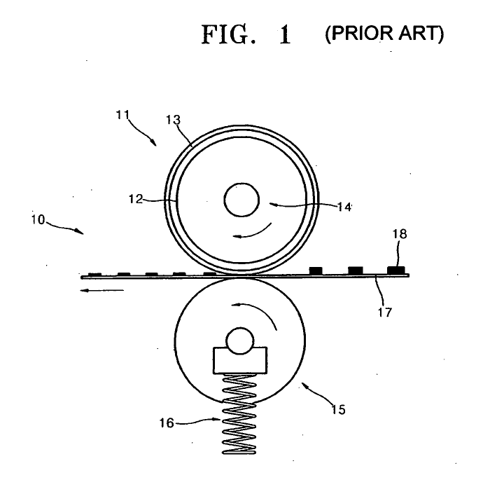

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

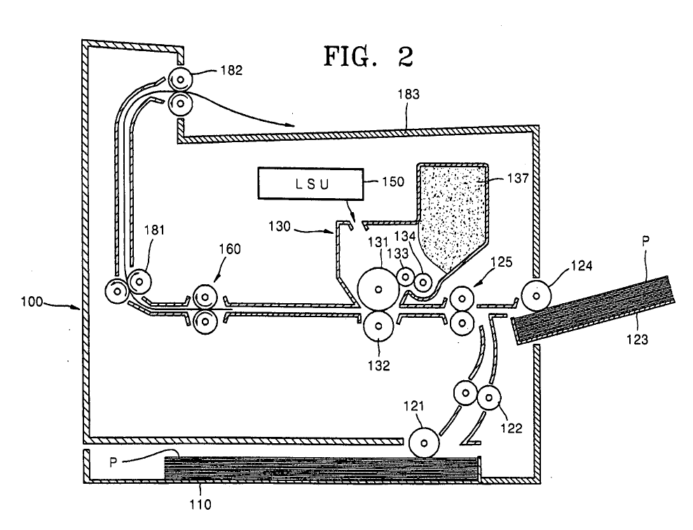

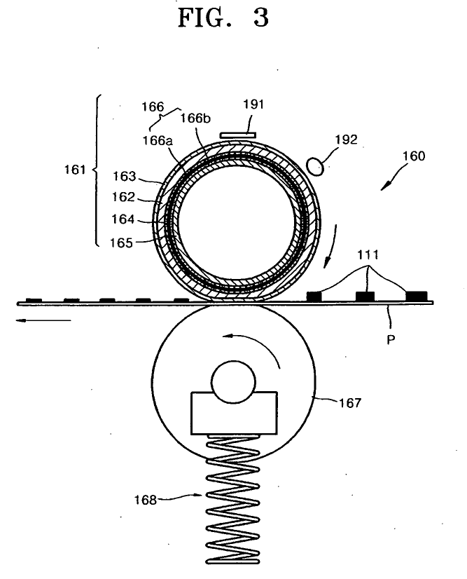

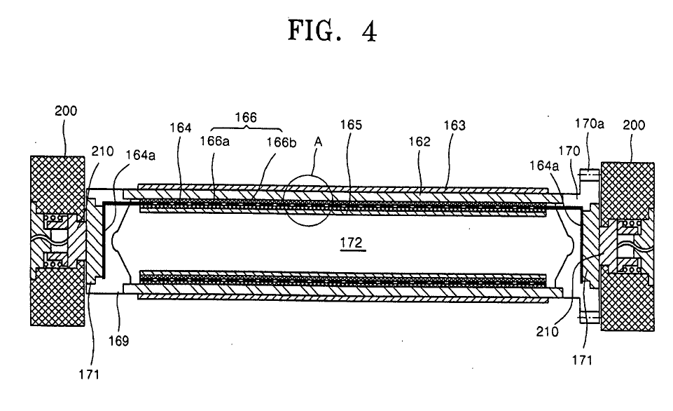

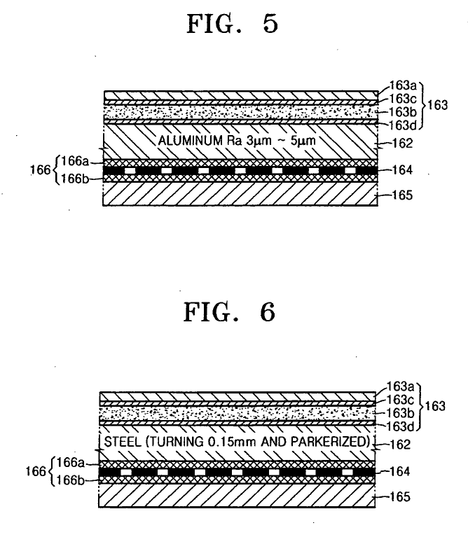

FIG. 2 is a schematic vertical sectional view illustrating an exemplary configuration of an image-forming apparatus having a fusing unit, FIG. 3 is a vertical sectional view illustrating a fusing unit of an image-forming apparatus, FIG. 4 is a cross sectional view illustrating the structure of the fuser roller in FIG. 3, FIG. 5 is an enlarged cross sectional view illustrating region A in FIG. 4 according to an embodiment of the present general inventive concept, and FIG. 6 is an enlarged cross sectional view of region A in FIG. 4 according to another embodiment of the present general inventive concept.

Referring to FIGS. 2 through 4, a cassette 110 to load print media (P) is removably installed at the bottom of a main body 100 of the image-forming apparatus, and a multi-purpose feeding tray 123 is installed at the side of the main body 100 to load the print media (P). Pick-up rollers 121 and 124 to pick up the print media (P) loaded respectively in the cassette 110 and the multi-purpose feeding tray 123 are respectively installed above the cassette 110 and tray 123.

A developing unit 130 and a transfer roller 132 are installed to develop an image on a print medium (P) that is picked up by the pick-up rollers 121 and 124 and conveyed along a conveying path by a conveying roller 122 and a roller 125, and transfer the image to the print medium (P).

The developing unit 130 includes a photosensitive medium 131 that accepts an electrostatic latent image formed on its surface by a light scanning unit (LSU) 150, a developing roller 133 to develop the electrostatic latent image which is installed in contact with the photosensitive medium 131, and a supplying roller 134 to supply toner from a toner tank 137 to the developing roller 133.

The transfer roller 132 is installed opposite to and contacting the photosensitive medium 131, to transfer the toner image formed on the photosensitive medium 131 to the print medium (P).

The toner image transferred to the print medium (P) by the transfer roller 132 is fused to the print medium (P) by means of a fusing unit 160 installed along the path on which the print medium (P) is conveyed, and the print medium (P) is outputted onto a paper output tray 183 outside of the main body 100 by paper output rollers 181 and 182.

Referring to FIG. 3, the fusing unit 160 applies heat and pressure to a toner image 111 transferred onto the print medium (P) to fuse the toner image 111 to the print medium (P). A fuser roller 161 that applies heat to the toner image 111, and a pressure roller 167 installed in surface contact with the fuser roller 161 that receives elastic force from an elastic member 168 urging the pressure roller 167 against the fuser roller 161, are provided for the fusing unit 160, and rotate in directions indicated by arrows in FIGS. 2 and 3.

The print medium (P) onto which the toner image 111 is transferred passes between contacting portions (hereinafter referred to as ‘nip’) of the fuser roller 161 and the pressure roller 167, and is subjected to heat and pressure so that the toner image 111 fuses to the print medium (P).

The fuser roller 161 includes a tubular fusing portion 162, an inner tube 165 inserted into the fusing portion 162, a heating portion 164, and an insulating portion 166 that insulates the heating portion 164 from the fusing portion 162 and the inner tube 165. The heating portion 164 may be disposed between the inner tube 165 and the tubular fusing portion 162.

The fusing portion 162 is open on either end and has a protective layer 163 provided around its outer surface. An end cap 169 and a power transfer end cap 170 (FIG. 4) are respectively installed at either end of the fusing portion 162, for example, by inserting into the open ends of the fusing portion 162. The structure of the power transfer end cap 170 may be the same as that of the end cap 169, with the addition of a power transfer portion 170a (e.g., gear teeth) that is connected to a driving unit (not illustrated) so that it can rotate when power is transferred thereto. Electrodes 171 are respectively installed on the end cap 169 and the power transfer end cap 170. The electrodes 171 contact power supply portions 210 elastically supported on a frame 200 and connected to a power supply unit (not shown) through a cable, and are supplied with current from the power supply portions 210. Accordingly, even while the fuser roller 161 is rotating, the electrodes 171 are in constant contact with the power supply portions 210 to receive current from the power supply unit through the cable and the power supply portions 210.

An interior space 172 of the fuser roller 161 is blocked by and virtually sealed from the outside by the end cap 169 and the power transfer end cap 170, which are inserted at either end of the fusing portion 162. Thus, the heat radiated from the heating portion 164 is transferred to the interior space 172 and heats the air inside the fuser roller 161 to quickly raise the temperature along the length of the fuser roller 161.

As illustrated in FIG. 5, the protective layer 163 is installed to surround the outer surface of the fusing portion 162, and includes an elastic layer 163b and a release layer 163a that is installed to enclose the outer surface of the elastic layer 163b, so that the protective layer 163 contacts the pressure roller 167 to elastically deform and form a nip. The release layer 163a may include a release material such as polytetrafluoroethylene, e.g., TEFLON, so that it can easily detach from the print medium (P) and the toner image 111.

Adhesive layers 163c and 163d are respectively provided between the elastic layer 163b and the release layer 163a and between the elastic layer 163b and the fusing portion 162. The adhesive layers 163c and 163d may be formed of a polymer.

The elastic layer 163b may be formed of a low-hardness LSR resin between 2-10 degrees according to Japanese Industrial Standards (JIS-A). Referring to FIG. 5, the fusing portion 162 in one embodiment of the general inventive concept may be formed of aluminum (Al) with a roughness factor of 3-5 μm.

The reason to set the roughness factor of the fusing portion 162 made of aluminum (Al) to 3-5 μm is that it will satisfy testing conditions allowing 100,000 sheets of print medium to be continuously printed with an image pattern covering 2% of a sheet surface area, without separation of the elastic layer 163b and the fusing portion 162.

These test results are displayed in Chart 1 below comparing changing roughness factors in cases where turning is used and not used.

| | CHART 1 | | | | | |
|---|---|---|---|---|---|---|
| | Roughness Factor | | | | | |
| | 0–1 μm | 1–2 μm | 2–3 μm | 3–4 μm | 4–5 μm | 5–6 μm |
| No Turning | X | X | □ | ◯ | ◯ | □ |
| 0.3 mm | X | X | X | X | □ | X |
| Turning | | | | | | |

Here, the roughness factor is the average roughness (Ra) at the middle line. The results are for a test conducted by successively printing 100,000 sheets of print medium with a 2% image coverage. (The average roughness, Ra, is the usual measure of roughness for machined surfaces. Ra is defined as the average of the absolute values of surface height variations measured from the mean surface level.)

The icons in Chart 1 signify the following. (These also apply to the icons in Chart 2, which appears below.)
∘: no peeling after 100,000 sheets printed and roller in good condition
□: normal peeling and defects occur after 50,000-100,000 sheets printed
X: peeling and defects occur below 50,000 sheets printed—inadequate

Chart 1 illustrates results taken when the outer surface of the fusing portion 162 is surface treated by turning at 0.3 mm (lower row). The roughness factor is measured in 1 μm increments from 0-6 μm. Chart 1 illustrates that, with the exception of roughness factor is 4-5 μm, all other results are inadequate. However, the turning at 4-5 μm still does not produce the desired result of no peeling after 100,100 sheets.

On the other hand, results taken when the outer surface of the fusing portion 162 is not turned (top row), and the roughness factor is again measured in 1 μm increments from 0-6 μm, illustrate that turning at 3-4 μm and 4-5 μm produce the desired results, and thus the optimum range for no turning is seen to be 3-5 μm. Here, turning is an operation that is used in turnery to cut a surface of a round structure by using a tool while turning (rotating) the round structure. The tool may have saw teeth having a pitch of 0.3 mm.

In an alternative embodiment of the general inventive concept illustrated in FIG. 6, the fusing portion 162 is made of steel, and its outer surface is surface treated by turning at 0.15 mm and then Parkerizing to produce desired results.

The reason for surface treating a fusing portion 162 made of steel is to be able to continuously pattern at least 2% of the surfaces of 100,000 sheets of print medium without the elastic layer 163b peeling off the fusing portion.

Under these conditions, test results obtained by varying the turning for cases where the outer surface of the fusing portion 162 has been and has not been Parkerized are illustrated in Chart 2 below.

| | CHART 2 | | | | | |
|---|---|---|---|---|---|---|
| | Turning | | | | | |
| | None | 0.1 mm | 0.15 mm | 0.2 mm | 0.3 mm | 0.5 mm |
| Surface Not | X | X | X | X | X | X |
| Parkerized | | | | | | |
| Surface | □ | □ | ◯ | □ | X | X |
| Parkerized | | | | | | |

Referring to the upper row in Chart 2, when the outer surface of the fusing portion 162 is not Parkerized and ranges are divided from zero (no) turning to 0.5 mm turning, all ranges are inadequate.

On the other hand, when the outer surface of the fusing portion 162 is Parkerized and ranges are divided from zero (no) turning to 0.5 mm turning, the range of 0.15 mm turning produces desired test results. In a Parkerizing process, when an iron product is dipped into a solution obtained by heating a first phosphate solution of a metal, such as manganese or zinc, to almost a boiling point, second and third phosphates of iron, which are insoluble, are formed on the surface of the iron product. This thin film is not soluable in water and is so dense as to properly cover the surface of the iron product. Thus, the thin film is effective in corrosion protection and serves as the base of painting.

The heating portion 164 disposed between the fusing portion 162 and the inner tube 165 may be installed so as to spirally enclose the outer surface of the inner tube 165. It receives a current from an external power source which it relays to resistive heating elements. The heating portion 164 has a lead portion 164a provided at either end to receive the current from the external power source. The leads 164a electrically contact the electrodes 171, respectively. Thus, the current from the external power source can be transferred to the heating portion 164. While in FIGS. 4 through 6, the resistive heating elements of the heating portion 164 have gaps therebetween for the sake of illustration, in reality the insulating portion 166 may fill the gaps because the thickness of the heating elements are thin.

As illustrated in FIGS. 5 and 6, the insulating portion 166 includes a first insulating portion 166a between the heating portion 164 and the fusing portion 162 and a second insulating portion 166b between the heating portion 164 and the inner tube 165.

Because the insulating portion 166 has high voltage withstanding characteristics, and high dielectric breakdown resistance, but it can be made thin, it is an efficient heat conductor. Favorable voltage withstanding characteristics allow the insulating portion 166 to withstand a predetermined external voltage applied thereto, and high dielectric breakdown resistance displays the characteristic of allowing no more than, for example, 10 mA of leakage current and preventing dielectric breakdown over, for example, a one-minute duration under a maximum withstanding voltage. Any material that fulfills these conditions may be used for the insulating portion 166.

The inner tube 165 has its outer surface enclosed by the heating portion 164 and is then inserted into the fusing portion 162 so that the heating portion 164 presses against the inner surface of the fusing portion 162. Accordingly, the inner tube 165, insulating portion 166, heating portion 164, and fusing portion 162 press together, and the heat radiated from the heating portion 164 is efficiently transferred to the surface of the fusing portion 162.

FIG. 3 illustrates a thermostat 191 to prevent overheating by disconnecting power when the surface temperature of the fusing portion 162 suddenly rises, and a thermistor 192 to measure the surface temperature of the fusing portion 162, Both are installed above the fuser roller 161.

For reference, a brief description of a method of manufacturing a fuser roller 161 will now be given.

The first insulating portion 166a is installed on the outer surface of the inner tube 165. The heating portion 164 is installed to spirally enclose the first insulating portion 166a. Then, the second insulating portion 166b is installed to enclose the heating portion 164.

The inner tube 165 with the heating portion 164, the first insulating portion 166a, and the second insulating portion 166b are then inserted into the fusing portion 162.

Next, both ends of the inner tube 165 are sealed, and a predetermined pressure is applied to the interior to expand the inner tube 165.

As the inner tube 165 expands, the heating portion 164, the first insulating portion 166a, and the second insulating portion 166b press against the inner surface of the fusing portion 162. The heating portion 164 is connected to the heating elements, and the gaps between the heating elements are filled by the first and second insulating portions 166a and 166b.

In order for the inner tube 165 to expand, it may be made of aluminum or another malleable (or, ductile) material. When the inner tube 165 is made of stainless steel or a similar material, the inner tube 165 with the heating portion 164, the first insulating portion 166a, and the second insulating portion 166b is inserted into the fusing portion 162.

Referring to FIGS. 2-6, the fusing unit 160 and the image-forming apparatus 100 may be formed by using a method, including forming the second insulating layer 166b on the inner tube 165, forming the heating portion 164 on the second insulating layer 166b, forming the first insulating layer 166a on the heating portion 164, forming the fusing portion on the first insulating layer 166a, and forming the protective layer 163 on the fusing portion 162. The fusing unit 160 and the image-forming apparatus may be formed using another method including inserting the inner tube 165 inside the fusing portion 162 with the heating portion 164.

As described above, the fuser roller for a fusing unit of an image-forming apparatus is surface treated with material corresponding to that of the fusing portion, increasing the strength of the coupling between the elastic layer and fusing portion is increased, so that peeling of the elastic layer can be prevented.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A fuser roller comprising:
a tubular fusing portion;
an inner tube disposed inside the fusing portion; and
a heating portion to enclose an outer surface of the inner tube, to press against an inner surface of the fusing portion, and to radiate heat,
wherein the fusing portion is surface treated to have a roughness factor of Ra 3-5 μm.

2. The fuser roller of claim 1, wherein the fusing portion comprises an aluminum material.

3. The fuser roller of claim 1, further comprising:
an elastic layer formed on the treated surface of the fusing portion, so that peeling of the elastic layer from the fusing portion is prevented.

4. The fuser roller of claim 1, further comprising:
an elastic layer with a hardness of JIS-A (Japanese Industrial Standards) 2-10 degrees that encloses an outer portion of the fusing portion.

5. A fuser roller comprising:
a tubular fusing portion;
an inner tube disposed inside into the fusing portion; and
a heating portion to enclose an outer surface of the inner tube, to press against an inner surface of the fusing portion, and to radiate heat,
wherein the fusing portion is treated by turning the fusing portion at 0.15 mm and being Parkerized.

6. The fuser roller of claim 5, wherein the fusing portion comprises a steel material.

7. The fusing roller of claim 5, further comprising:
an elastic layer formed on the fusing portion, so that a coupling between the fusing portion and the elastic layer is increased.

8. The fuser roller of claim 5, further comprising:
an elastic layer with a hardness of JIS-A (Japanese Industrial Standards) 2-10 degrees that encloses an outer surface of the fusing portion.

9. An image-forming apparatus comprising:
a developing unit to develop an electrostatic latent image; and
a fusing unit comprising a fusing portion to attach the developed image to a print medium, a fuser roller comprising a heating portion to radiate heat, and a pressure roller engaged with the fuser roller,
wherein the fusing portion has a roughness factor of Ra 3-5 μm.

10. The image-forming apparatus of claim 9, wherein the fusing portion comprises aluminum.

11. The image-forming apparatus of claim 9, further comprising:
an elastic layer formed on the fusing portion, so that a coupling between the fusing portion and the elastic layer is increased.

12. The image-forming apparatus of claim 9, further comprising:
an elastic layer with a hardness of JIS-A (Japanese Industrial Standards) 2-10 degrees that encloses an outer portion of the fusing portion.

13. An image-forming apparatus comprising:
a developing unit to develop an electrostatic latent image; and
a fusing unit comprising a fusing portion to attach the developed image to a print medium, a fuser roller comprising a heating portion to radiate heat, and a pressure roller engaged with the fuser roller,
wherein the fusing portion is treated by turning the fusing portion at 0.15 mm and being Parkerized.

14. The image-forming apparatus of claim 13, wherein the fusing portion comprises a steel material.

15. The image-forming apparatus of claim 13, further comprising:
an elastic layer formed on the fusing portion, so that a coupling between the fusing portion and the elastic layer is increased

16. The image-forming apparatus of claim 13, further comprising:
an elastic layer with a hardness of JIS-A (Japanese Industrial Standards) 2-10 degrees that encloses an outer surface of the fusing portion.

17. A method of forming a fuser roller usable in an image-forming apparatus, the method comprising:
forming a heating portion between a tubular fusing portion and an inner tube to generate heat,
wherein the fusing portion is surface treated to have a roughness factor of Ra 3-5 μm.

18. The method of claim 17, further comprising:
forming an elastic layer on the treated surface of the fusing portion to prevent peeling of the elastic layer from the fusing portion.

19. A method of forming a fuser roller usable in an image-forming apparatus, the method comprising:
forming a heater portion between a tubular fusing portion and an inner tube to generate heat,
wherein the fusing portion is treated by turning the fusing portion at 0.15 mm and being Parkerized.

20. The method of claim 19, further comprising:
forming an elastic layer on the fusing portion to increase a coupling between the elastic layer and the fusing portion.
